(19) United States
(12) Patent Application Publication
(10) Pub. No.: US 2010/0057345 A1
(43) Pub. Date: Mar. 4, 2010

(54) SYSTEM AND METHOD FOR ITEM IDENTIFICATION, LOCATION AND NAVIGATION INSTRUCTION THERETO

(75) Inventors: SUSANNA BALDI, Rome (IT); GIOVANNA BENEFAZIO, Rome (IT); CRISTINA BONANNI, Rome (IT); PAOLA CARLESIMO, Rome (IT); MARIA RITA CELESTINI, Rome (IT); GIULIA FARINELLI, Rome (IT); LOUISA IENTILE, Rome (IT); GABRIELLA SANTORO, Rome (IT)

Correspondence Address: IBM - SPP;SHIMOKAJI & ASSOCIATES, P.C., 8911 Research Drive, Irvine, CA, 92618, US

(73) Assignee: INTERNATIONAL BUSINESS MACHINES CORPORATION, Armonk, NY (US)

(21) Appl. No.: 12/199,981

(22) Filed: Aug. 28, 2008

(51) Int. Cl. G01C 21/00

(52) U.S. Cl. 701/202

(57) ABSTRACT

A method and system for identifying, locating and providing navigational instructions among distributed items is disclosed. The method includes the steps of designating a plurality of items, identifying each of the items, accessing a data base to obtain at least location information associated with each identified item, providing a map of the location of each item, determining a distance to each item, determining a first item based on a user's position and sorting the list by distance with respect to the first item and providing navigational instructions to each item on the list.

### BACKGROUND OF THE INVENTION

The present invention relates to the field of inventory control and more particularly to a method and system for identifying locations of items and providing an ordered list and directions to the identified items.

In the field of shopping, whether in a supermarket, or a clothing store or a large discount store, a customer typically must search the aisles to locate one or more desired items. When the user is familiar with the store layout the location of desired items is typically known, but may be time consuming as a method of proceeding from the location of one item to the next item may be done in a random manner. In situations where the store is unfamiliar to the customer, the shopping experience is further burdened as desired items must be searched. This is typically performed by reading overhead signs that may be located at the beginning of an aisle.

This method is very time consuming and burdensome as items may be missed and the same aisle may be traversed more than once. Even with a prepared list in hand, the user may have to search the aisle to find the different items on the list as two unrelated items may be within the same aisle.

Hence, there is a need in the industry for a method and system that would allow a customer to locate desired items within a store and provide a means for directing the customer from one item location to another.

### SUMMARY OF THE INVENTION

A method for identifying, locating and providing navigation to at least one desired item is disclosed. The method comprises completing a preprinted form, at least a portion of which includes a plurality of items grouped in at least one category of items, scanning the form to identify each of the plurality of items indicated on the completed form, said scanning being performed at a current position, accessing a data base containing information associated with each of the plurality of items identified on said form, said information including at least one of: a location, a price, and a quantity, preparing a list of each item indicated to have a quantity of at least one, preparing a map identifying a location of each of the plurality of items indicated on said list, determining a difference between each of said item locations and said current position, said difference considering deviations from a straight line path between said locations to overcome obstacles between each of said item locations, determining a first item on said list as that item having a smallest difference between said current position and each of said items, determining a difference between each item on said list and said selected first item, determining a difference between each of said items on said list, resorting said list of said plurality of items based on said first item and a shortest difference between each of said subsequent plurality of items on said list, selecting said first item on said list, providing navigation instruction from said current position to a location associated with said first item on said list, determining when said location of said first item is reached, selecting a next item on said list and providing navigation instruction to a location of each of said subsequent items on said list from a location of an immediately preceding item on said list.

### BRIEF DESCRIPTION OF THE FIGURES

FIG. 1 illustrates a system for identifying, locating and providing navigation instruction in accordance with the principles of the invention;

FIG. 2 illustrates a flowchart of an exemplary process for identifying, locating and providing navigation instruction for the system shown in FIG. 1; and

FIG. 3 illustrates in further detail the processing system shown in FIG. 1.

### DETAILED DESCRIPTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

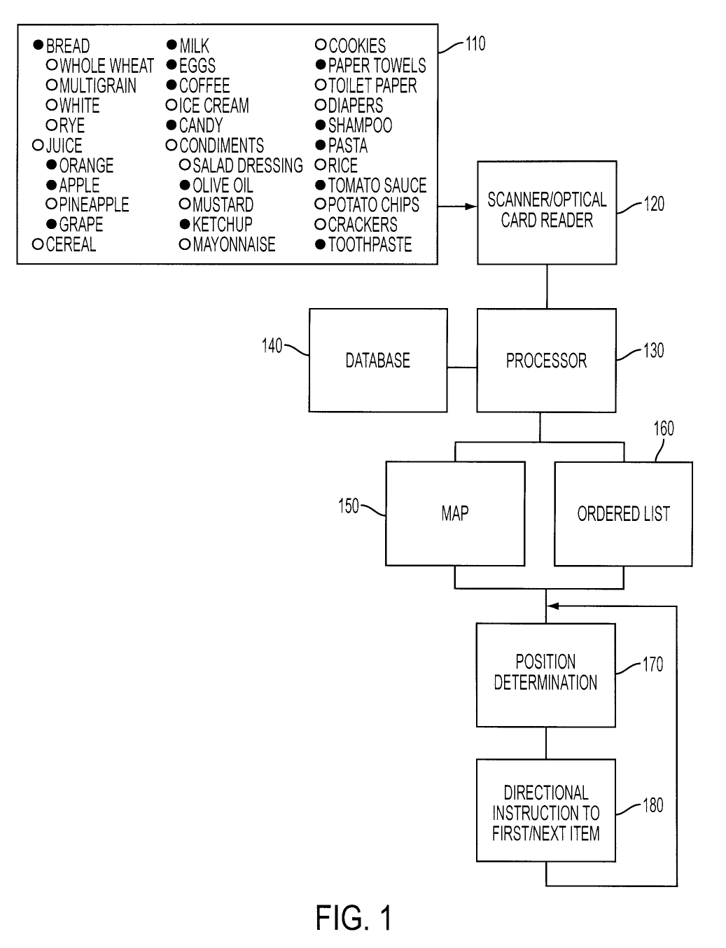

FIG. 1 illustrates an exemplary embodiment of a system in accordance with the principles of the invention. In this exemplary embodiment, a user or customer may obtain a preprinted card 110 that includes one or more items that are associated with general categories of items that may be allocated within the store. For example, in a supermarket situation, the preprinted card 110 may include general categories, such as Bread, Juice, Cereal, Meat, Fish, Dairy, Fruit, Vegetable, Paper Goods, Condiments etc. In addition, selected ones of the general categories may be further divided into general subcategories. Generalized subcategories of category Meat, for example, may include beef, veal, pork, chicken, etc. while category Dairy may include subcategories such as milk, eggs, cheese, etc. In the illustrated embodiment of the preprinted card, the category Condiments is shown having subcategories, Salad Dressing, Olive Oil, Mustard, Ketchup, Mayonnaise. The specific form of the preprinted card is not critical to the invention disclosed and it would be recognized by those skilled in the art that the format of the card shown herein is merely illustrative and is not intended to limit the scope of the invention to that shown herein. Similar types of preprinted cards may be selected for a clothing store, where the general categories may be men's wear, woman's wear, children, infants, jewelry, etc. Subcategories may be developed for each of these categories.

Although not shown, it would be further recognized that the preprinted card may include additional areas that allow the user to write one or more items that are not included on the card. For example, the user or customer may desire a specific brand of orange juice and may indicate that desire by scribing that information on the card.

Hence, while the instant invention is described with regard to a supermarket, it would be recognized that the invention described herein may be applicable to other types of stores or inventory control systems that include a plurality of geographically distributed items.

In accordance with principles of the invention, a user may identify one or more items by category and/or subcategory by marking entries on the preprinted card 110. The partially filled preprinted card containing the desired items may then be scanned by scanner 120 to identify the items identified by general category, subcategory and any specific items that may be included on the preprinted card 110. Although a scanner is referred to as processing the preprinted card, it would be recognized that scanner 120 may represent an optical card reader or similar type devices.

The information regarding the desired items on the preprinted card 110 may then be provided to processor 130, which may then access an inventory database 140 that includes information regarding each item in the store. Information such as, type, manufacturer, brand name, supplier, location, price, promotion, discount, and quantity/availability of each item may be contained in the database. A list is prepared of each item that is available. That is, there is at least one item in the inventory.

Based on the information of each item, a location map 150 may be generated showing the location of each item indicated on the preprinted card 110. The location may represent the location of items within the general category, the location of items within the subcategory and/or the location of specifically designated items. A list of each item identified and located may also be produced 160.

Based on the locations of the desired items, information may be provided to direct the user to each item considering the distance between each item. The distance measurement may consider that the items are stored in aisles and that a direct path to each item cannot be used. Thus, the distance determination considers obstacles that may be between two different items or the route that must be taken to proceed from one item to a next item. In one aspect of the invention, the list may be generated in an ordered manner based on the distance between items 160. In this case, the ordered list may represent the shortest distance between two identified items. In addition, the first item on the list may represent the shortest distance between an item on the list and the user's current position and the list resorted based on the selected first item and the distances between the items on the list such that the items are ordered by progressively greater distances. A user's position may be determined at step 170 based on a location of a device being used or may be determined based on a Global Positional Satellite (GPS) system location.

As the customer or user may proceed at step 180 from a first item on the list to a next item, directional information, such as turn right, turn left, straight ahead, may be provided to the user. This information may be provided via audio and/or visible means. For example, a shopping cart may include a processing system that includes a display and speaker system that may provide the visual and/or oral directional cues to the user.

As the user proceeds from one item to the next on the ordered list, the user's position may be determined at step 170. The user's position may be determined using GPS coordinates that may be provided to the processing system. For example, the processing system may include a GPS receiver. In another embodiment, the processing system may be in communication with one or more sensors that detect information regarding location markers within the store. This communication may be short-range wireless or optical or other similar communication methods. Navigational instruction may be provided to the user to direct the user from the location of one item to a next item, in the designated order, on the list.

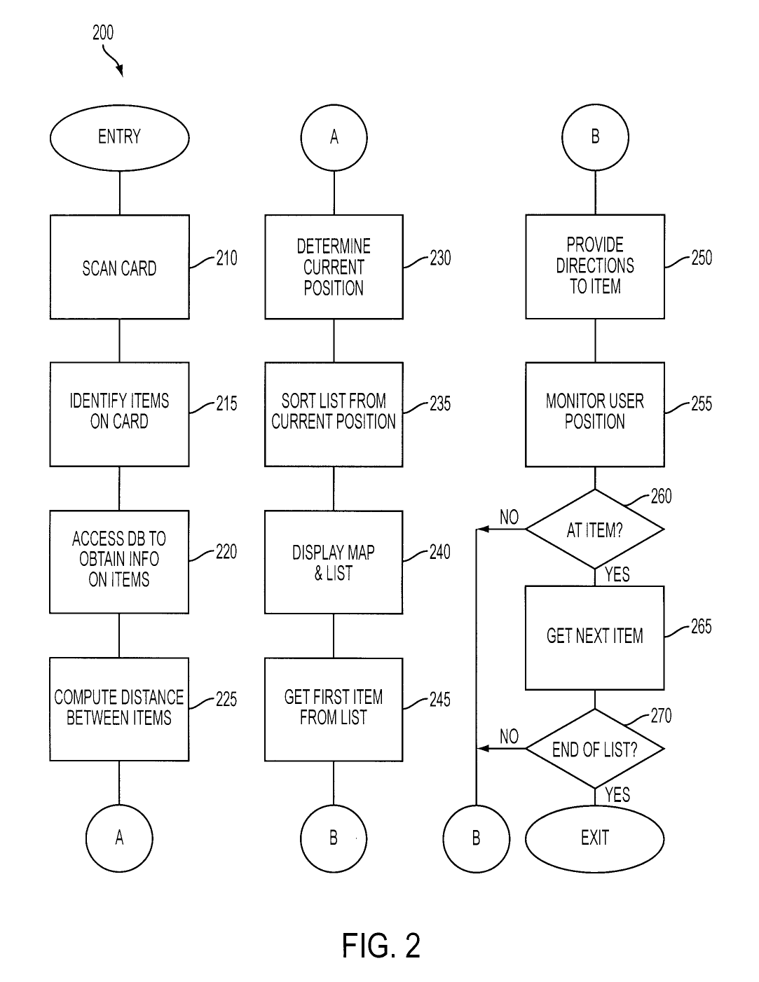

FIG. 2 illustrates a flowchart of an exemplary process 200 in accordance with the principles of the invention. In this illustrated embodiment, a preprinted card is scanned at block 120. Items designated on the preprinted card are then identified at block 215. At block 220, access to a database is preformed to obtain information regarding each identified item. The information regarding the identified items may be location, the price, the quantity or availability of the items and any discount specials or promotions. A list of identified items may then be generated which includes the price of each item based on manufacturer, brand name or supplier. A total cost of all the items may be determined based on manufacturer, brand name, or supplier. For example, brand name items may cost more than store brand items and this information may be included in the total cost. Also information regarding promotions or specials can be indicated to provide information that would not be available to the customer. At block 225, distances between the locations of items may be determined. At block 230, a current position of the user may be determined. This current position may be determined using a GPS system or location identifiers that are distributed throughout the store or facility. At block 235, the list of items may then be stored based on the current position so that the first item on the list may represent the item closest (shortest distance) to the user. The other items on the list may then be sorted based on their distance between each other.

At block 240 a map of the location of each item on the list may be provided to the user. The map may be printed or displayed on a display system. Similarly the sorted list of items may be presented to the user either in printed or displayed form. In one aspect of the invention, the list of items may then be provided to a second physical processing system that may be used to direct the user to each item.

At block 245, the first item on the list is selected and at block 250 directional instructions are provided to the user to direct the user to this selected item. The instructions may be provided using a combination of audio and visual cues. At block 255, the user's position is monitored as the user follows the provided instructions. At block 260, a determination is made whether the user has arrived at the selected item. If the answer is negative, then directions are provided to the user at block 250.

Otherwise, if the user has arrived at the item, the next item is selected from the list at block 265. At block 270 a determination is made whether all the items on the list have been obtained. If the answer is negative, then processing proceeds to block 250 where directions are provided to the user to the next selected item. Otherwise processing is completed. In one aspect of the invention, directions may be provided from the location of the last item on the list to the nearest checkout.

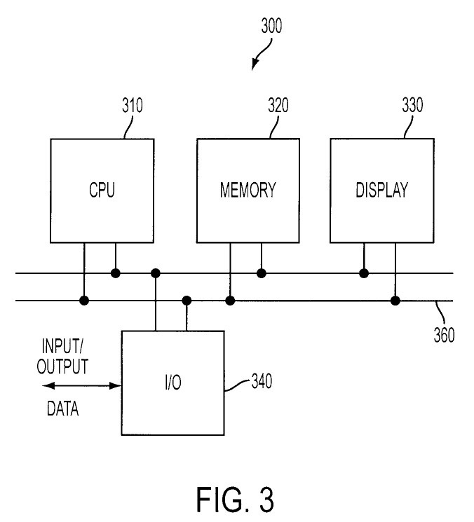

FIG. 3 illustrates an exemplary system 300 for implementing the processing shown in FIG. 2, in accordance with the principles of the invention as shown in FIG. 1. In this exemplary system embodiment, a processor (CPU) 310, memory 320, display 330, and I/O device 340 may each be in communication via a communication bus 360. Processor 310 may be any type of processor that receives known inputs and performs one or more processing steps under the direction of programming instructions. Processor 310 may be CISC (complete instruction set computer) or RISC (reduced instruction set computer) type processor. Memory 320 may be, for example, a solid-state semiconductor memory represented as RAM, ROM, EPROM, Flash, etc., that may store instructions that provide instructions to processor 310. The instructions, i.e., code, may be stored in permanent memory, e.g., PROM, and variable or changeable data may be stored in RAM.

Display 330 may be used to present the map and list to the user. Although not shown a printer may also be used to present information to the user.

I/O device 340 may provide a means for inputting and outputting information to and from processor 310. For example, I/O device 340 may receive information from scanner 120 or current position information from sensors (not shown) or a GPS receiving system (not shown). This information may be provided to processor 310 to process the current position of the user. The current position may be displayed on display 330. Although not shown it would be appreciated that the data may be provided from or to a network, such as a WAN, LAN, POTS and the Internet. In addition communication from scanner 120 or sensors (not shown) may be infrared or wireless (e.g., Bluetooth).

It would be recognized by those skilled in the art, that the invention described herein can take the form of an entirely hardware embodiment, an entirely software embodiment, or an embodiment containing both hardware and software elements. In an exemplary embodiment, the invention may be implemented in software, which includes but is not limited to firmware, resident software, microcode, etc.

In this case, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

It is to be understood that the specific embodiments of the invention that have been described are merely illustrative of certain applications of the principle of the present invention. Numerous modifications may be made to a system and method for identifying, locating and providing navigation instruction described herein without departing from the spirit and scope of the present invention. For example, while a preprinted card is disclosed herein, it would be recognized that an electronic form of data transfer may be implemented, e.g., USB port. In addition, the scanner unit and processor unit may be a separate or integrated units. For example, scanner units may be distributed around a facility and information regarding identified items may be provided to a separate processing unit on a shopping cart that performs the user position monitoring and item selection. In another embodiment of the invention, the scanning unit and processing unit may be integrated and included on a shopping cart. In this case, a customer may insert a preprinted card or electronic device into the integrated unit and the processor may scan or identify designated items, communicate wirelessly with a database to obtain information regarding each designated item and then provide navigational instruction to the user via a display screen on the shopping cart.

It should be understood, of course, that the foregoing relates to exemplary embodiments of the invention and that modifications may be made without departing from the spirit and scope of the invention as set forth in the following claims.

What is claimed is:

1. A method for identifying, locating and providing navigation to at least one desired item comprising:
completing a preprinted form, at least a portion of which includes a plurality of items grouped in at least one category of items,
scanning the form to identify each of the plurality of items indicated on the completed form, said scanning being performed at a current position;
accessing a data base containing information associated with each of the plurality of items identified on said form, said information including at least one of: a location, a price, and a quantity;
preparing a list of each item indicated to have a quantity of at least one;
preparing a map identifying a location of each of the plurality of items indicated on said list;
determining a difference between each of said item locations and said current position, said difference considering deviations from a straight line path between said locations to overcome obstacles between each of said item locations;
determining a first item on said list as that item having a smallest difference between said current position and each of said items;
determining a difference between each item on said list and said selected first item;
determining a difference between each of said items on said list;
resorting said list of said plurality of items based on said first item and a shortest difference between each of said subsequent plurality of items on said list;
selecting said first item on said list;
providing navigation instruction from said current position to a location associated with said first item on said list;
determining when said location of said first item is reached;
selecting a next item on said list; and
providing navigation instruction to a location of each of said subsequent items on said list from a location of an immediately preceding item on said list.
